(19) United States
(12) Patent Application Publication
(10) Pub. No.: US 2014/0252857 A1
(43) Pub. Date: Sep. 11, 2014

(54) SMART HOME CONTROL SYSTEM

(71) Applicant: ASUSTeK COMPUTER INC., Taipei (TW)

(72) Inventors: Wei-Chen WU, TAIPEI (TW); Li-Ru LAI, TAIPEI (TW)

(73) Assignee: ASUSTeK COMPUTER INC., Taipei (TW)

(21) Appl. No.: 14/184,720

(22) Filed: Feb. 20, 2014

Related U.S. Application Data
(60) Provisional application No. 61/773,160, filed on Mar. 6, 2013.

(30) Foreign Application Priority Data
Jan. 9, 2014 (CN) 201410009370.1

(51) Int. Cl. H02J 4/00

(52) U.S. Cl. CPC H02J 4/00
USPC 307/39; 307/116

(57) ABSTRACT

A smart home control system is provided. The smart home control system includes a first sensing unit, a control unit and a control center. The first sensing unit is electrically connected to a first electronic device. The first sensing unit senses a first state within a first region. The control unit is electrically connected to the first sensing unit. The control unit generates a sensing signal according to the first state. The control center is connected to a cloud system. The control center receives the sensing signal, and generates a control signal via the cloud system and transmits the control signal to the control unit. The control unit controls the first electronic device to be turned on or turned off according to the control signal.

### CROSS-REFERENCE TO RELATED APPLICATION

This application claims the priority benefit of U.S. provisional application Ser. No. 61/773,160, filed on Mar. 6, 2013 and CN application serial No. 201410009370.1, filed on Jan. 9, 2014. The entirety of the above-mentioned patent application are hereby incorporated by reference herein and made a part of specification.

### BACKGROUND OF THE INVENTION

1. Field of the Invention

The invention relates to a smart home control system and, more particularly, to a smart home control system including a sensing unit.

2. Description of the Related Art

In a conventional home system, a user can remotely control and manage home appliances via a portable device. However, each home appliances is operated and controlled manually, therefore, the managing effect of the home system is limited. Even though a home appliance can be controlled remotely, the state of each home appliance cannot be revealed promptly while using. In other words, the home appliances only can be controlled according to a user, but not to their practical state under using, which results low control efficiency of the home system.

### BRIEF SUMMARY OF THE INVENTION

A smart home control system is provided. The smart home control system includes sensing units which are electrically connected to electronic devices. The sensing units sense various environmental states, and generate a corresponding control signal according to different environmental states to control the corresponding electronic device.

A smart home control system is provided. The smart home control system includes a first sensing unit, a control unit and a control center. The first sensing unit is electrically connected to a first electronic device. The first sensing unit senses a first state within a first region. The control unit is electrically connected to the first sensing unit. The control unit generates a sensing signal according to the first state. The control center is connected to a cloud system. The control center receives the sensing signal, generates a control signal via the cloud system and transmits it to the control unit. The control unit controls the first electronic device to be turned on or turned off according to the control signal.

In sum, the smart home control system can sense an environmental state via a sensing unit, and transmit a control signal to control an electronic device to be turned on or turned off after the cloud system calculates. Furthermore, the sensing unit and the electronic device can be connected in an extending or stacking manner. Thus, the user can control each electronic device under different states, and the control of the electronic devices is more flexible.

These and other features, aspects and advantages of the present invention will become better understood with regard to the following description, appended claims, and accompanying drawings.

### BRIEF DESCRIPTION OF THE DRAWINGS

FIG. 1 is a block diagram showing a smart home control system in an embodiment;

FIG. 2A is a schematic diagram showing a smart home control system in a first embodiment;

FIG. 2B is a schematic diagram showing a smart home control system in a second embodiment; and

FIG. 3 is a schematic diagram showing a first sensing unit, a second sensing unit and a control unit in an embodiment.

### DETAILED DESCRIPTION OF THE EMBODIMENTS

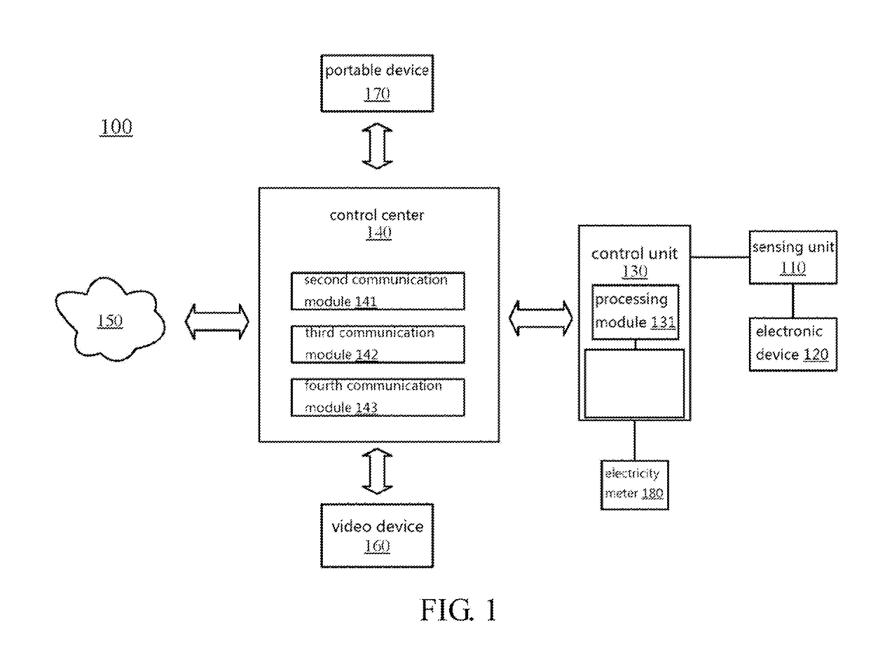

FIG. 1 is a block diagram showing a smart home control system in an embodiment. The smart home control system 100 includes a sensing unit 110, an electronic device 120, a control unit 130, a control center 140 and a cloud system 150. In the embodiment, only one sensing unit 110 and one electronic device 120 are shown, which is not limited herein. In other words, the number of the sensing unit 110 and the electronic device 120 can be increased according to requirements.

In the embodiment, the sensing unit 110 is electrically connected to the electronic device 120. The sensing unit 110 detects a state within a region. The control unit 130 is electrically connected to the sensing unit 110. The control unit 130 generates a sensing signal according to the state sensed by the sensing unit 110, and transmits the sensing signal to the control center 140. The control center 140 receives different sensing signals generated according to different states sensed by the sensing units 110 of the smart home control system 100, and transmits the sensing signals to the cloud system 150 for calculation. The cloud system 150 includes a database, and the database includes some public data or using habits record of the user. Then, the cloud system 150 generates a control signal corresponding to the sensing signal according to the data in the database, and transmits the control signal back to the control center 140. The control center 140 transmits the control signal back to the control unit 130. The control unit 130 controls the electronic device 120 to be turned on or turned off according to the control signal.

In the embodiment, the sensing unit 110 includes a sensor. The sensor can sense a state within a region. In the embodiment, the sensor may include a light sensor, a sound sensor, a temperature sensor, a humidity sensor, a pressure sensor or a distance sensor. In other words, the states sensed by the sensor include brightness, volume, temperature, humidity, a pressure on an object or a distance between the sensor and an object, which is not limited herein. Moreover, the electronic device 120 may include a fan, an air conditioner, a lamp, a dehumidifier, a computer, a washer, a coffee machine, an electronic door lock or a security system, which is not limited herein.

In the embodiment, the cloud system 150 computes a large quantity of data, and has the ability to run a program or application on many connected electronic devices at the same time. In detail, when the smart home control system 100 includes a plurality of the sensing units 110 which are connected to multiple electronic devices 120, the cloud system 150 receives the sensing signals from different sensing units 110, and records the using habits of the user corresponding to each electronic device 120 in the database. Then, the cloud system 150 generates the corresponding control signal via calculating according to the data recorded in the database to control the electronic device 120.

The smart home control system 100 can use the sensing unit 110 as an eye (such as a video lens), a nose (such as a gas and smog sensing element), an ear (such as a microphone), a mouse (such as a loudspeaker) and skin (such as a temperature and humidity sensing element) to sense various signals at home. Then, the cloud system 150 acts as a brain to receive the signals, analyzes and determines, and generates the corresponding control signal to control different electronic devices 120. Thus, the smart home control system 100 can achieve automatic control and management, and improve the efficiency of controlling and managing the home system.

On the other hand, in another embodiment, the control center 140 and the cloud system 150 may be integrated together. In other words, within the scope of the invention, persons having ordinary skill in the art can design a different control center to achieve the function of generating the corresponding control signal via the cloud system to control an electronic device according to a sensing signal from a sensing unit.

In the embodiment, the control unit 130 may include a processing module 131 and a first communication module 132. The processing module 131 generates the corresponding sensing signal according to the state sensed by the sensing unit 110. In operation, the processing module 131 may compare the sensed state with a threshold value, and generates the sensing signal according to a comparing result. For example, when the temperature sensed by a temperature sensor of the sensing unit 110 is 28° C., the processing module 131 compares the temperature with threshold temperature (such as 25° C.), and generates a sensing signal according to the comparing result.

The processing module 131 may also generate a sensing signal directly according to the sensed state. For example, if a pressure sensor in the sensing unit 110 senses that a pressure is applied on a chair, the processing module 131 generates a sensing signal.

Then, the control unit 130 transmits the sensing signal to the control center 140 via the first communication module 132. The control center 140 generates the corresponding control signal via the cloud system 150 according the received sensing signal, and transmits the control signal to the control unit 130. The processing module 131 controls the electronic device 120 to be turned on or turned off according to the control signal. In the previous example, when the environment temperature is higher than threshold temperature, the processing module 131 turns on a fan or an air conditioner according to the control signal, or when a pressure is applied on a chair, the processing module 131 turns on a lamp or a computer according to the control signal.

In the embodiment, the control center 140 may include a second communication module 141 and a third communication module 142. In operation, the control center 140 can establish a first communicating connection with the cloud system 150 via the second communication module 141, and it can transmit information with the cloud system 150 via the first communicating connection. Moreover, the control center 140 can establish a second communicating connection with the first communication module 132 via the third communication module 142, and it can transmit information with the control unit 130 via the second communicating connection. In the embodiment, the second communication module 141 may include a wireless router, a wireless access point, an xDSL router, a 3G/4G router or a worldwide interoperability for microwave access (Wimax) router, and the first communication module 132 and the third communication module 142 may include a blue-tooth router or a Zigbee router, which is not limited herein.

In the embodiment, the control unit 130 may also be electrically connected to another router (not shown), and thus a transmitting distance between the control unit 130 and the control center 140 is increased, which is not limited herein.

In the embodiment, the smart home control system 100 further includes a video device 160. Only one video device 160 is shown in the embodiment, but it is not limited. In other words, the number of the video device 160 can be increased according to requirements. The video device 160 may include a loudspeaker, a video lens, a video cassette recorder (VCR) and a television. Moreover, the control center 140 also includes a fourth communication module 143 to establish a third communicating connection with the video device 160, and transmits information with the video device 160 via the third communicating connection. In detail, the control center 140 can be connected to the video device 160 via a wireless network or a local area network (LAN), and controls the video device 160, such as turning on the television or the loudspeaker and selecting a channel or a song.

In the embodiment, except for controlling the electronic device 120 via the sensing unit 110 according to the sensed state, the user can also transmit an input command to the control center 140 and directly controls the electronic device 120 via a portable device 170. The portable device 170 may include a mobile phone, a personal digital assistant (PDA) and a notebook computer, which is not limited herein.

In operation, the user can directly transmit the input command to the control center 140 via the portable device 170, and the control center 140 generates the control signal via the cloud system 150 according to the input command to control the electronic device 120 or the video device 160. For example, the user can directly transmit an input command to the control center 140 to turn off the air conditioner by a mobile phone, and the control center 140 generates the corresponding control signal via the cloud system 150 according to the input command to turn off the air conditioner.

In another operation, the user can also set a condition and transmit an input command to the control center 140 via the portable device 170, and the control center 140 generates the corresponding control signal via the cloud system 150 according to the input command. However, when the condition is met, the control center 140 transmits the control signal to control the electronic device 120 or the video device 160. For example, the user sets a condition (such as at 3:00 p.m.) and an input command (such as turning on the television and the VCR) to the control center 140 via a mobile phone. The control center 140 generates the corresponding control signal according to the input command for turning on the television and the VCR. When it is at 3:00 p.m., the control center 140 transmits the control signal to turn on the television and the VCR.

In the embodiment, the control unit 130 is electrically connected to an electricity meter 180. The electricity meter 180 is used to calculate the power consumption of the electronic device 120. Furthermore, the control unit 130 can also transmit relating information (such as the power degrees consumed by the electronic device 120) to the portable device 170 via the control center 140, and thus the user can manage the state of each electronic device.

The sensing units of the smart home control system may be connected to each other, and thus the user can control at least one electronic device according to a plurality of states, which makes the application of the sensing units more flexible and achieves a management of diverse home appliances.

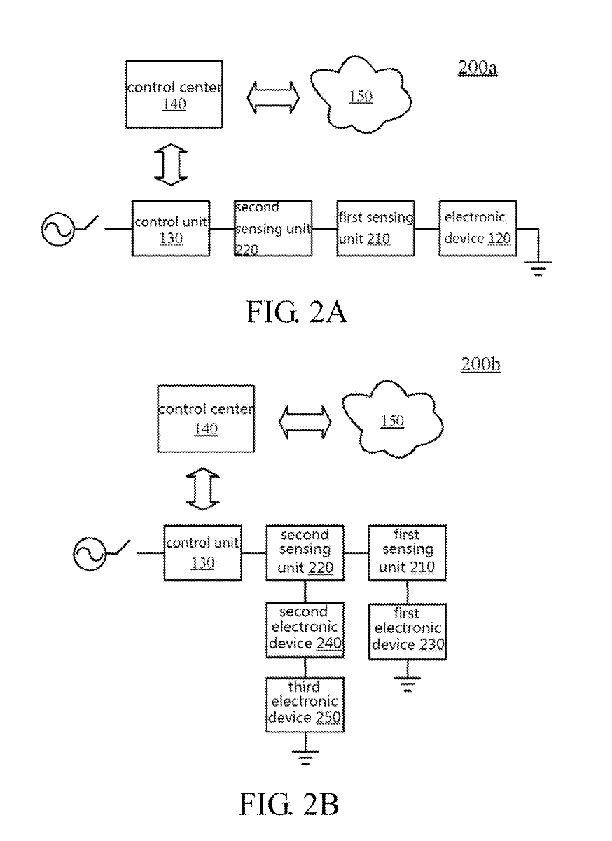

FIG. 2A is a schematic diagram showing a smart home control system 200a in a first embodiment. In the embodiment, the smart home control system 200a includes a first sensing unit 210 and a second sensing unit 220. The second sensing unit 220 is electrically connected between the control unit 130 and the first sensing unit 210. Moreover, the electronic device 120 is electrically connected to one of the first sensing unit 210 and the second sensing unit 220 (the electronic device 120 is electrically connected to the first sensing unit 210 in the embodiment).

In operation, the control unit 130 controls the electronic device 120 according to the first state sensed by the first sensing unit 210 and the second state sensed by the second sensing unit 220. In detail, when the first sensing unit 210 is connected to the second sensing unit 220 in series, the control unit 130 determines that the relation of the first state and the second state is similar with the logic of an AND Gate. In other words, the control unit 130 generates the sensing signal to the control center 140 according to the first state and the second state. The control center 140 receives the sensing signal and calculates via the cloud system 150 to generate the corresponding control signal, and then transmits the control signal to the control unit 130. The control unit 130 controls the electronic device 120 to be turned on or turned off according to the control signal.

For example, when the environment temperature sensed by a temperature sensor of the first sensing unit 210 is higher than the threshold temperature and the environment humidity sensed by a humidity sensor of the second sensing unit 220 is higher than the threshold humidity, the control unit 130 generates the corresponding sensing signal to the control center 140. The control center 140 generates the corresponding control signal according to the sensing signal and transmits the control signal to the control unit 130. The control unit 130 controls the electronic device 120 to be turned on or turned off (such as turning on an air conditioner) according to the control signal.

FIG. 2B is a schematic diagram showing a smart home control system 200b in the second embodiment. In the embodiment, the smart home control system 200b further includes a first electronic device 230, a second electronic device 240 and a third electronic device 250. As shown in FIG. 2B, the first electronic device 230 is electrically connected to the first sensing unit 210, the third electronic device 250 is electrically connected to the second electronic device 240, and the second electronic device 240 is electrically connected to the second sensing unit 220.

In operation, since the first sensing unit 210 and the second sensing unit 220 are electrically connected to different electronic devices, the first electronic device 230 can be controlled according the first state sensed by the first sensing unit 210, the second electronic device 240 and the third electronic device 250 are controlled according to the second state sensed by the second sensing unit 220, and they are controlled separately. In detail, when the first sensing unit 210 and the second sensing unit 220 are connected in parallel, and the first sensing unit 210 and the second sensing unit 220 are electrically connected to at least one electronic device, respectively, the control unit 130 determines that the relation of the first state and the second state is similar with the logic of an OR Gate. In other words, the control unit 130 may generate the first sensing signal or the second sensing signal, respectively, according to the first state or the second state and transmits the first sensing signal or the second sensing signal to the control center 140. The control center 140 generates a first control signal or a second control signal via the cloud system 150 according to the first sensing signal or the second sensing signal, and transmits the first control signal or the second control signal to the control unit 130. The control unit 130 controls the first electronic device 230, or the second electronic device 240 and the third electronic device 250 to be turned off or turned on according to the first control signal or the second control signal.

Thus, one control unit can be used to connect different sensing units in a connecting way shown in FIG. 2B to control the corresponding electronic device, respectively, and it does not need to connect a control unit to the sensing unit of each electronic device.

Thus, a plurality of the sensing units can be flexibly connected to the electronic devices in different connecting ways in the previous embodiments, and the electronic devices can be controlled under different states, which make the control of the electronic devices meet the requirements. Although only two sensing units and the connection thereof are illustrated in the previous embodiment, it is just an example for convenient illustration and is not limited. In other words, any person with ordinary skill in the art can select more than two sensing units according to requirements, and determines their connecting ways according to whether at least two sensing units are electrically connected to different electronic devices, respectively, so as to make the control of the electronic devices meet the user requirements.

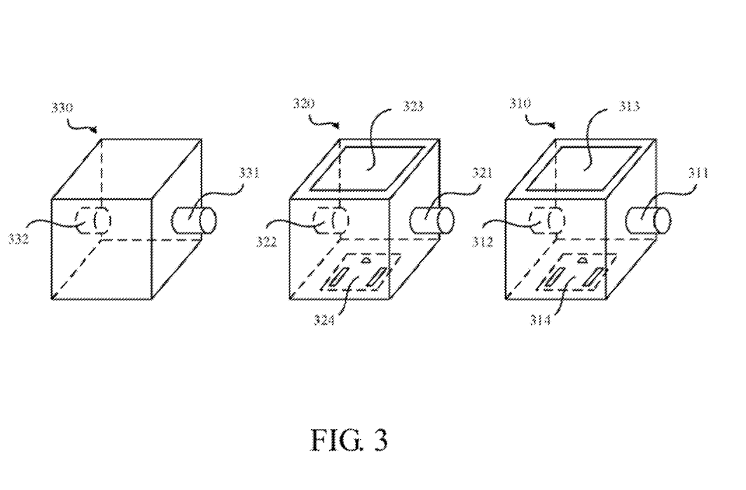

FIG. 3 is a schematic diagram showing a first sensing unit 310, a second sensing unit 320 and a control unit 330 in an embodiment.

As shown in FIG. 3, the first sensing unit 310, the second sensing unit 320 and the control unit 330 are cubes, and the processing module and the first communication module are disposed in the cube of the control unit 330 (not shown). In other embodiments, the first sensing unit 310, the second sensing unit 320 and the control unit 330 may also be combined with an appearance as a cylinder, a cone or a polyhedron, which is not limited herein.

A first surface of the first sensing unit 310 has a first connecting part 311. A second surface of the first sensing unit 310 has a second connecting part 312. A third surface of the first sensing unit 310 has a first sensor 313. A fourth surface of the first sensing unit 310 has a first socket 314.

Similarly, a first surface of the second sensing unit 320 has a first connecting part 321. A second surface of the second sensing unit 320 has a second connecting part 322. A third surface of the second sensing unit 320 has a second sensor 323. A fourth surface of the second sensing unit 320 has a second socket 324. On the other hand, a first surface of the control unit 330 also has a first connecting part 331 and a second surface of the control unit 330 has a second connecting part 332.

In the embodiment, as shown in FIG. 3, the second sensing unit 320 is electrically connected to the first sensing unit 310 via the first connecting part 321 and the second connecting part 312. Moreover, the first connecting part 331 of the control unit 330 is connected to the second connecting part 322 of the second sensing unit 320, and thus the control unit 330 is electrically connected to the second sensing unit 320.

In the embodiment, the first connecting parts 311, 321 and 331 are protruding structures, and the second connecting part 312, 322 and 332 are concave structures. In other embodiments, the first connecting parts 311, 321 and 331, the second connecting parts 312, 322 and 332 may be magnetic components, so as to make the first sensing unit 310, the second sensing unit 320 and the control unit 330 electrically connected to each other via the magnetic force. The shape of the first connecting part and the second connecting part is not limited as long as they can make the first sensing unit 310, the second sensing unit 320 and the control unit 330 connected to each other.

On the other hand, the electronic devices (not shown) can be electrically connected to the first sensing unit 310 and the second sensing unit 320, respectively, via the first socket 314 and the second socket 324. Furthermore, the connection of the first sensing unit 310 and the second sensing unit 320 is similar with that in the previous embodiment, which is omitted herein.

As stated above, the sensing units and the control unit are cubes, and the sensing units are connected to each other in an extending or stacking manner, which can make each electronic device in the smart home system to be connected to at least one single sensing unit. Thus, the electronic devices can be flexibly controlled under different states, and the user requirements of controlling the electronic device under different states can be met. On the other hand, the using state of each electronic device can be gotten by a portable device in the smart home system via the cloud system, and the electronic devices can be controlled and managed effectively. Moreover, the cloud system can cooperate with an electricity meter to manage the power consumption of each electronic device according the recorded using habits and public data (such as electricity calculating methods of different companies), and further provides a most economical using mode of the electronic appliance to the user to save power.

Although the present invention has been described in considerable detail with reference to certain preferred embodiments thereof, the disclosure is not for limiting the scope. Persons having ordinary skill in the art may make various modifications and changes without departing from the scope. Therefore, the scope of the appended claims should not be limited to the description of the preferred embodiments described above.

What is claimed is:

1. A smart home control system, comprising:
a first sensing unit electrically connected to a first electronic device, wherein the first sensing unit senses a first state within a first region;
a control unit electrically connected to the first sensing unit, wherein the control unit generates a sensing signal according to the first state; and
a control center connected to a cloud system, wherein the control center receives the sensing signal, and generates a control signal via the cloud system and transmits the control signal to the control unit;
wherein the control unit controls the first electronic device to be turned on or turned off according to the control signal.

2. The smart home control system according to claim 1, wherein the smart home control system further includes a second sensing unit, and the second sensing unit senses a second state within a second region.

3. The smart home control system according to claim 2, wherein the second sensing unit is electrically connected between the control unit and the first sensing unit, and the control unit generates the sensing signal according to the first state and the second state.

4. The smart home control system according to claim 2, wherein the smart home control system further includes a second electronic device, the second sensing unit is electrically connected to the control unit, the second electronic device is electrically connected to the second sensing unit, the control unit generates the corresponding sensing signal according to the first state or the second state, respectively, the control center receives the corresponding sensing signal and generates the corresponding control signal via the cloud system and transmits the control signal to the control unit, and the control unit controls the first electronic device or the second electronic device to be turned on or turned off according to the corresponding control signal.

5. The smart home control system according to claim 2, wherein the control unit, the first sensing unit and the second sensing unit are combined with an appearance as a cube, a cylinder, a cone or a polyhedron.

6. The smart home control system according to claim 2, wherein the control unit, the first sensing unit and the second sensing unit include a first connecting part and a second connecting part, respectively, and the control unit, the first sensing unit and the second sensing unit are connected with each other via the first connecting part and the second connecting part.

7. The smart home control system according to claim 1, wherein the first sensing unit includes a socket, and the first electronic device is electrically connected to the first sensing unit via the socket.

8. The smart home control system according to claim 1, wherein the control center includes:
a first communication module establishing a first communicating connection with the cloud system; and
a second communication module establishing a second communicating connection with the control unit.

9. The smart home control system according to claim 1, wherein the smart home control system further includes at least one portable device, the portable device transmits an input command to the control center, and the control center generates the control signal according to the input command and transmits the control signal to the control unit to control the first electronic device to be turned on or turned off.

10. The smart home control system according to claim 1, wherein the control unit is electrically connected to an electricity meter, and the electricity meter calculates the power consumption of the first electronic device.

11. The smart home control system according to claim 1, wherein the first sensing unit includes a sensor, and the sensor is a light sensor, a sound sensor, a temperature sensor, a humidity sensor, a pressure sensor or a distance sensor.

12. The smart home control system according to claim 1, wherein the cloud system includes a database, and the cloud system provides the control signal to the control unit according to the database.
